(19) United States
(12) Patent Application Publication
(10) Pub. No.: US 2014/0085461 A1
(43) Pub. Date: Mar. 27, 2014

(54) IMAGE SPECIFICATION SYSTEM, IMAGE SPECIFICATION APPARATUS, IMAGE SPECIFICATION METHOD AND STORAGE MEDIUM TO SPECIFY IMAGE OF PREDETERMINED TIME FROM A PLURALITY OF IMAGES

(71) Applicant: CASIO COMPUTER CO., LTD., Tokyo (JP)

(72) Inventor: Kazuaki ABE, Iruma-shi (JP)

(73) Assignee: CASIO COMPUTER CO., LTD., Tokyo (JP)

(21) Appl. No.: 14/030,955

(22) Filed: Sep. 18, 2013

(30) Foreign Application Priority Data
Sep. 21, 2012 (JP) 2012-207761

(51) Int. Cl. H04N 7/18; G06T 7/00

(52) U.S. Cl. CPC H04N 7/181; G06T 7/0044
USPC 348/142

(57) ABSTRACT

An image specification system includes a sender and a receiver. The sender includes a determination unit and a sending unit. The receiver includes a receiving unit, an obtainment unit and an image specification unit. The receiving unit receives first time information on a time at which a positional relationship between a first object provided with the sender and a second object is a predetermined state, sent from the sending unit when the determination unit determines that the positional relationship is the predetermined state. The obtainment unit obtains images successively captured by an image pickup unit and correlated with respective second time information on times at which the respective images are captured. The image specification unit specifies, from the images, an image correlated with second time information corresponding to the first time information.

### CROSS REFERENCE TO RELATED APPLICATION

This application is based upon and claims the benefit of priority under 35 USC 119 of Japanese Patent Application No. 2012-207761 filed on Sep. 21, 2012, the entire disclosure of which, including the description, claims, drawings, and abstract, is incorporated herein by reference in its entirety.

### BACKGROUND OF THE INVENTION

1. Field of the Invention

The present invention relates to an image specification system, an image specification apparatus, an image specification method and a storage medium to specify an image of a predetermined time from a plurality of images.

2. Description of the Related Art

There has been known an art by which impact sounds produced when balls are hit with a golf club are detected with a microphone, and digest images of a moving image of the time captured with a digital camera are displayed, which is disclosed in Japanese Patent Application Laid-Open Publication No. 2008-236124.

### SUMMARY OF THE INVENTION

According to a first aspect of the present invention, there is provided an image specification system including: a sender; and a receiver, the sender including: a determination unit which determines whether a positional relationship between a first object provided with the sender and a second object is a predetermined state; and a sending unit which sends first time information on a time at which the positional relationship is the predetermined state to the receiver when the determination unit determines that the positional relationship is the predetermined state, and the receiver including: a receiving unit which receives the first time information sent from the sending unit; an obtainment unit which obtains a plurality of images successively captured by an image pickup unit and correlated with respective second time information on times at which the respective images are captured; and an image specification unit which specifies, from the images correlated with the respective second time information, an image correlated with second time information corresponding to the first time information.

According to a second aspect of the present invention, there is provided an image specification method using a sender and a receiver, the image specification method including: a determination step of determining whether a positional relationship between a first object provided with the sender and a second object is a predetermined state; a sending step of sending first time information on a time at which the positional relationship is the predetermined state to the receiver when. that the positional relationship is the predetermined state is determined in the determination step; a receiving step of receiving the first time information sent from the sender; an obtainment step of obtaining a plurality of images successively captured by an image pickup unit and correlated with respective second time information on times at which, the respective images are captured; and an image specification step of specifying, from the images correlated with the respective second time information, an image correlated with second time information corresponding to the first time information.

According to a third aspect of the present invention, there is provided an image specification apparatus including: a receiving unit which receives first time information on a time at which a positional relationship between a first object and a second object is a predetermined state from an external device; an obtainment unit which obtains a plurality of images successively captured by an image pickup unit and correlated with respective second time information on times at which the respective images are captured; and an image specification unit which specifies, from the images correlated with the respective second time information, an image correlated with second time information corresponding to the first time information.

According to a fourth aspect of the present invention, there is provided an image specification method including: a receiving step of receiving first time information on a time at which a positional relationship between a first object and a second object is a predetermined state from an external device; an obtainment step of obtaining a plurality of images successively captured by an image pickup unit and correlated with respective second time information on times at which the respective images are captured; and an image specification step of specifying, from the images correlated with the respective second time information, an image correlated with second time information corresponding to the first time information.

According to a fifth aspect of the present invention, there is provided a computer readable storage medium where a program is stored, the program making a computer function as: a first obtainment unit which obtains first time information on a time at which a positional relationship between a first object and a second object is a predetermined state from an external device; a second obtainment unit which obtains a plurality of images successively captured by an image pickup unit and correlated with respective second time information on times at which the respective images are captured; and an image specification unit which specifies, from the images correlated with the respective second time information, an image correlated with second time information corresponding to the first time information.

According to a sixth aspect of the present invention, there is provided an image specification apparatus including: a first obtainment unit which obtains motion information on motion of a subject correlated with first time information on the motion; a first specification unit which specifies a time at which a positional relationship between a first object and a second object is a predetermined state based on the motion information and the first time information; a second obtainment unit which obtains a plurality of images successively captured by an image pickup unit and correlated with respective second time information on times at which the respective images are captured; and a second specification unit which specifies, from the images correlated with the respective second time information, an image correlated with second time information corresponding to the specified time.

According to a seventh aspect of the present invention, there is provided an image specification method including: a first obtainment step of obtaining motion information on motion of a subject correlated with first time information on the motion; a first specification step of specifying a time at which a positional relationship between a first object and a second object is a predetermined state based on the motion information and the first time information; a second obtainment step of obtaining a plurality of images successively captured by an image pickup unit and correlated with respective second time information on times at which the respective images are captured; and a second specification step of specifying, from the images correlated with the respective second time information, an image correlated with second time information corresponding to the specified time.

According to an eighth aspect of the present invention, there is provided a computer readable storage medium where a program is stored, the program making a computer function as: a first obtainment unit which obtains motion information on motion of a subject correlated with first time information on the motion; a first specification unit which specifies a time at which a positional relationship between a first object and a second object is a predetermined state based on the motion information and the first time information; a second obtainment unit which obtains a plurality of images successively captured by an image pickup unit and correlated with respective second time information on times at which the respective images are captured; and a second specification unit which specifies, from the images correlated with the respective second time information, an image correlated with second time information corresponding to the specified time.

### BRIEF DESCRIPTION OF THE DRAWINGS

The present invention will become more fully understood from the detailed description given hereinafter and the appended drawings, which are given byway of illustration only and thus are not intended as a definition of the limits of the present invention, wherein:

FIG. 1 schematically shows the configuration of an image specification system of an embodiment to which the present invention is applied;

FIG. 2 is a block diagram schematically showing the configuration of a tool terminal of the image specification system shown in FIG. 1;

FIG. 3 schematically shows a state in which the tool terminal shown in FIG. 2 is attached to a tennis racket;

FIG. 4 schematically shows a state in which a tennis ball is hit with the tennis racket to which the tool terminal shown in FIG. 2 is attached;

FIG. 5 schematically shows outputs of an angular velocity detection unit of the tool terminal shown in FIG. 2;

FIG. 6 is a block diagram schematically showing the configuration of an image pickup apparatus of the image specification system shown in FIG. 1;

FIG. 7 is a flowchart showing an example of operation of an image specification process performed by the image specification system shown in FIG. 1;

FIG. 8A shows an example of an image in the image specification process shown in FIG. 7;

FIG. 8B shows an example of an image in the image specification process shown in FIG. 7;

FIG. 8C shows an example of an image in the image specification process shown in FIG. 7;

FIG. 8D shows an example of an image in the image specification process shown in FIG. 7;

FIG. 9 is a flowchart showing an example of operation of a state judgment process performed by the image pickup apparatus shown in FIG. 6;

FIG. 10A schematically shows a state judgment screen relevant to the state judgment process shown in FIG. 9;

FIG. 10B schematically shows a state judgment screen relevant to the state judgment process shown in FIG. 9; and

FIG. 11 shows an example of an image in the state judgment process shown in FIG. 9.

### DETAILED DESCRIPTION OF THE PREFERRED EMBODIMENT

In the following, an embodiment of the present invention is described with reference to the drawings. However, the present invention is not limited to the illustrated embodiment.

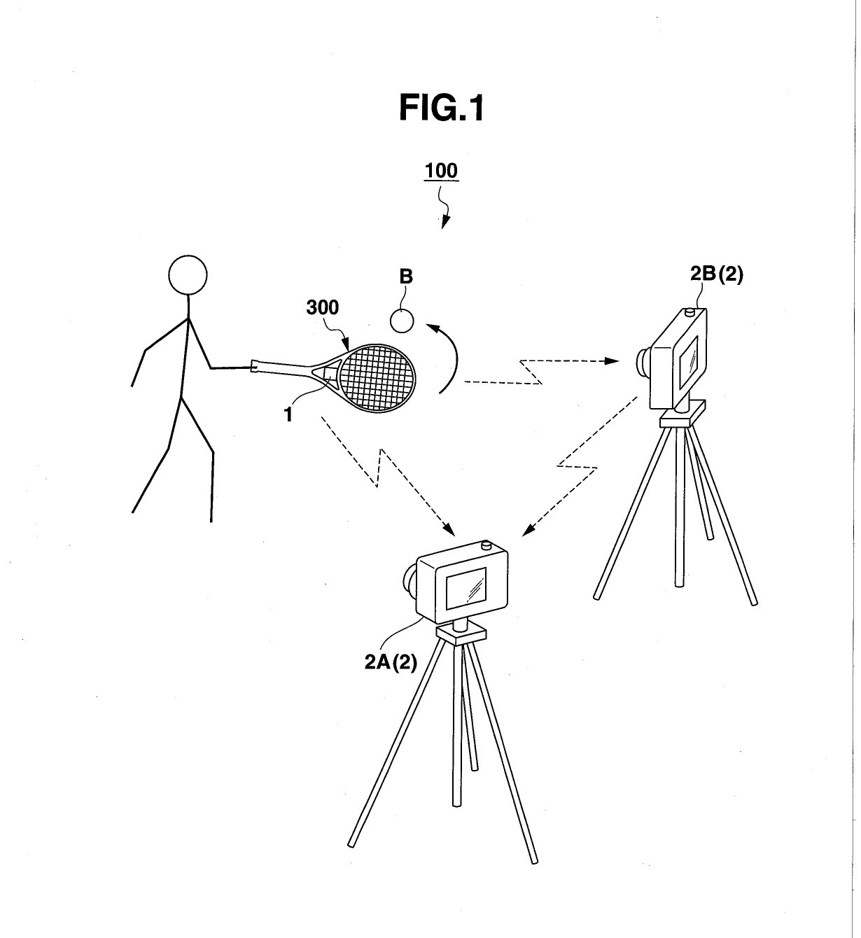

FIG. 1 schematically shows the configuration of an image specification system 100 of an embodiment to which the present invention is applied.

As shown in FIG. 1, the image specification system 100 of the embodiment includes: a tool terminal (sender) 1 attached to a tennis racket 300 to be fixed thereto; and a plurality of image pickup apparatuses (receiver) 2 which are connected to the tool terminal 1 via a wireless communication line to communicate therewith and which image user's motion to hit a tennis ball B with the tennis racket 300.

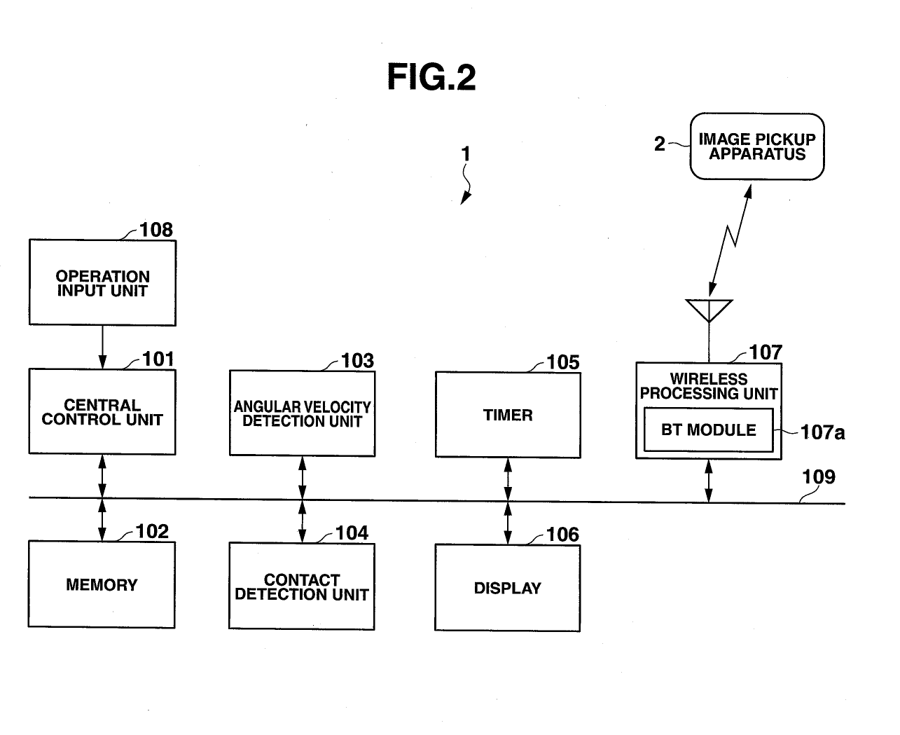

First, the tool terminal 1 is described with reference to FIGS. 2 to 5.

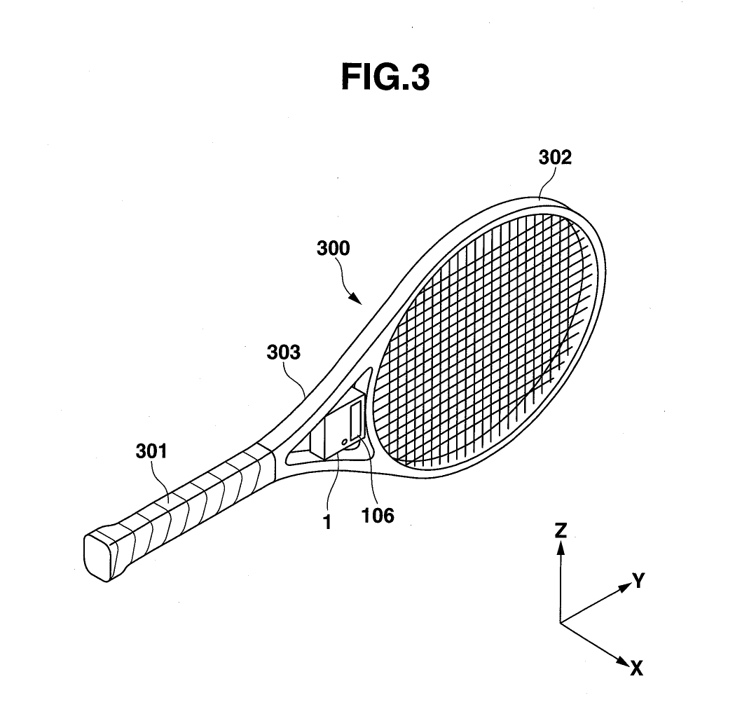

FIG. 2 is a block diagram schematically showing the configuration of the tool terminal 1. FIG. 3 schematically shows a state in which the tool terminal 1 is attached to the tennis racket 300.

In the following, a direction which is approximately perpendicular to the face of the tennis racket 300 is referred to as an X axis direction, a direction which is approximately perpendicular to the X axis direction and is the extending direction of a grip part 301 is referred to as a Y axis direction, and a direction which is approximately perpendicular to the X axis direction and to the Y axis direction is referred to as a Z axis direction.

As shown in FIG. 2, the tool terminal 1 of the embodiment includes a central control unit 101, a memory 102, an angular velocity detection unit 103, a contact detection unit 104 (a determination unit), a timer unit 105, a display unit 106, a wireless processing unit 107 and an operation input unit 108.

The central control unit 101, the memory 102, the angular velocity detection unit 103, the contact detection unit 104, the timer unit 105, the display unit 106 and the wireless processing unit 107 are connected to each other via a bus line 109.

As shown in FIG. 3, for example, the tool terminal 1 is detachably attached to the tennis racket (tool) 300 with which the tennis ball B is hit. More specifically, the tool terminal 1 is attached to the inside of a shaft part 303 which is disposed between the grip (holding) part 301 held by a user of the tennis racket 300 and a head part 302 constituting the face of the tennis racket 300.

The center of the tool terminal 1 is positioned on the Y axis in the extending direction of the grip part 301 inside the shaft part 303, for example. The tool terminal 1 may be directly attached to the shaft part 303 or attached thereto with a predetermined jig (not shown).

The central control unit 101 controls the units and the like of the tool terminal 1. More specifically, the central control unit 101 includes a CPU (Central Processing Unit), a RAM (Random Access Memory) and a ROM (Read Only Memory) (all not shown). The central control unit 101 performs various control operations in accordance with various process programs (not shown) for the tool terminal 1 stored in the ROM. The CPU stores results of the various processes in a storage region in the RAM and displays the results on the display unit 106 as needed.

The RAM includes: a program storage region where, for example, the process programs to be executed by the CPU are opened; and a data storage region where, for example, input data and the results generated by the execution of the process programs are stored.

The ROM stores therein, for example, programs in a form of program codes readable by a computer, such as a system program executable by the tool terminal 1 and the process programs executable by the system program, and data used to execute the process programs.

The memory 102 is constituted of, for example, a DRAM (Dynamic Random Access Memory) or the like and temporarily stores therein, for example, data processed by the central control unit 101 and the like.

The angular velocity detection unit 103 detects an angular velocity of the tool terminal 1 which rotates around a predetermined axis.

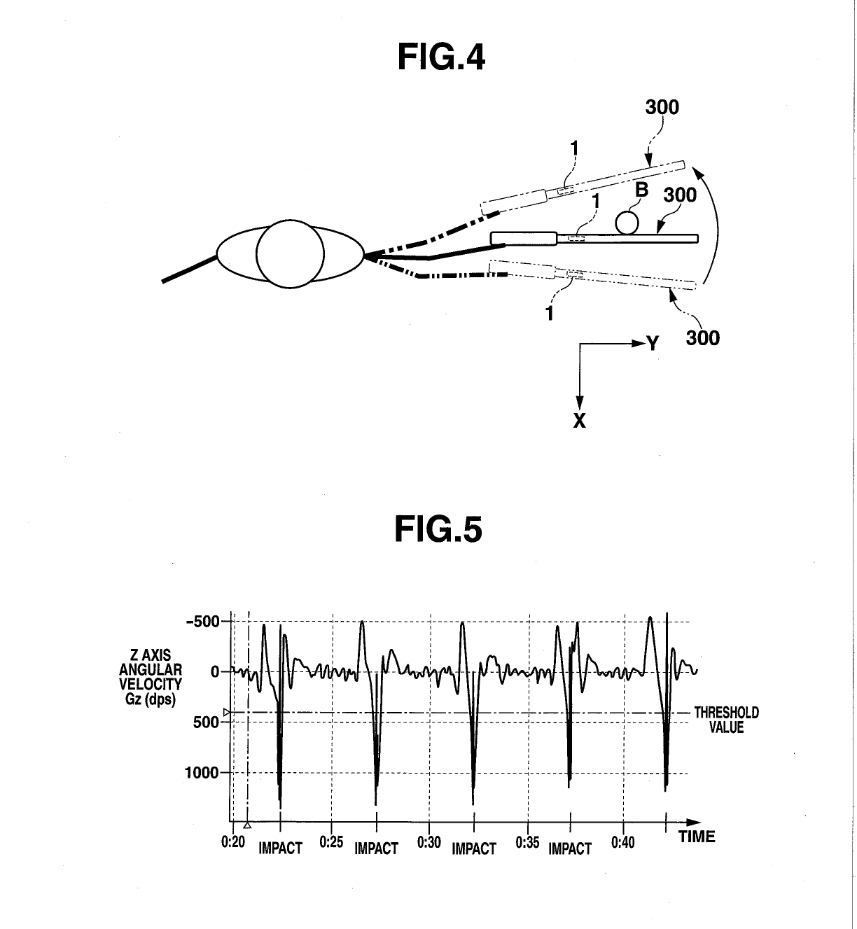

That is, the angular velocity detection unit 103 detects an angular velocity of the tool terminal 1 which rotates around a predetermined axis (for example, the Z axis) when a user makes motion to hit the tennis ball B with the tennis racket (tool) 300. More specifically, the angular velocity detection unit 103 detects a Z axis angular velocity Gz of the tool terminal 1 rotating around the Z axis, which is approximately parallel to the face (a surface) of the tennis racket 300, the face including a hitting part to hit the tennis ball B, and approximately perpendicular to the extending direction of the grip part 301 (see FIG. 4). Then, the angular velocity detection unit 103 outputs the detected values of the Z axis angular velocity Gz to the contact detection unit 104.

FIG. 4 schematically shows a state in which a right-handed user hits the tennis ball B with the tennis racket 300 with the forehand, from above the user in the Z axis direction.

The contact detection unit 104 detects contact (impact) of the tennis ball B onto the tennis racket 300.

That is, the contact detection unit 104 detects contact between the tennis racket (first object) 300 and the tennis ball (second object) B. More specifically, the contact detection unit 104 detects contact between the tennis racket 300 and the tennis ball B, namely, determines whether or not the tennis racket 300 and the tennis ball B contact with each other, on the basis of the Z axis angular velocity Gz detected by the angular velocity detection unit 103.

When a user hits the tennis ball B with the tennis racket 300 to which the tool terminal 1 is attached, the value of the z axis angular velocity Gz just before the tennis ball B contacts the face of the tennis racket 300 is below a predetermined threshold value, and the value of the z axis angular velocity Gz just after the tennis ball B contacts the face of the tennis racket 300 exceeds the predetermined threshold value (see FIG. 5). Hence, the contact detection unit 104 detects timing at which the tennis racket 300 and the tennis ball B contact with each other from the value of the Z axis angular velocity Gz using the predetermined threshold value as a reference. Then, the contact detection unit 104 outputs timing information which indicates the detected timing of the contact to the timer unit 105.

The timer unit 105 includes a timer or a timer circuit (both not shown) and keeps track of the current time to generate time information. More specifically, the timer unit 105 catches the time at which the tennis ball B and the tennis racket (tool) 300 contact with each other in response to input of the timing information output from the contact detection unit 104 to generate contact time information on the time of the contact (contact time). Then, the timer unit 105 outputs the generated contact time information to the wireless processing unit 107.

The timer unit 105 may specify, for example, a date and/or a day of week on the basis of the contact time information.

The display unit 106 is disposed at a predetermined point on the surface of the tool terminal 1 (see FIG. 3). The display unit 106 includes a seven-segment liquid crystal display panel or a light-emitting diode and controls lighting up/out of each segment or the light-emitting diode to display various pieces of information thereon, for example.

The display unit 106 may display thereon various pieces of information such as the speed and the amount of rotation of the tennis ball B found by predetermined methods when the tennis ball B is hit with the tennis racket 300, for example.

The wireless processing unit 107 performs wireless communication with the image pickup apparatuses 2 to which the wireless processing unit 107 (tool terminal 1) is connected via the predetermined wireless communication line.

More specifically, the wireless processing unit 107 includes, for example, a Bluetooth® module (BT module) 107a, and the BT module 107a performs wireless communication with BT modules 203a of wireless processing units 203 (described below) of the image pickup apparatuses 2 in accordance with the Bluetooth standard. That is, the BT module 107a performs a communication setting process called “pairing” in advance so that the BT module 107a and communication destination devices (the image pickup apparatuses 2, for example) exchange device information and authentication key data each other in a form of wireless signals. Once the communication setting process is done, the BT module 107a (tool terminal 1) is automatically or semi-automatically connected/disconnected to/from the communication destination devices without performing the communication setting process again.

The BT module 107a sends the contact time information on the time at which the tennis ball B and the tennis racket 300 contact with each other to the image pickup apparatuses (image specification apparatuses) 2 via the predetermined wireless communication line in response to the detection of the contact between the tennis ball B and the tennis racket (tool) 300 by the contact detection unit 104. For example, when the contact time information on the time at which the tennis ball B and the tennis racket 300 contact with each other output from the timer unit 105 is input, the BT module 107a sends the contact time information to the image pickup apparatuses 2 via the predetermined wireless communication line.

The wireless processing unit 107 may include, for example, a wireless LAN (Local Area Network) module to perform wireless communication with the wireless processing units 203 of the image pickup apparatuses 2.

The operation input unit 108 includes: data input keys to input numerical values, characters and the like; up, down, right and left movement keys for data selection, moving operations and the like; and various function keys. The operation input unit 108 outputs press signals corresponding to the keys pressed by a user to the CPU of the central control unit 101.

As the operation input unit 108, a touch panel (not shown) may be disposed on a display screen of the display unit 106 so that various instructions according to the touched points on the touch panel are input.

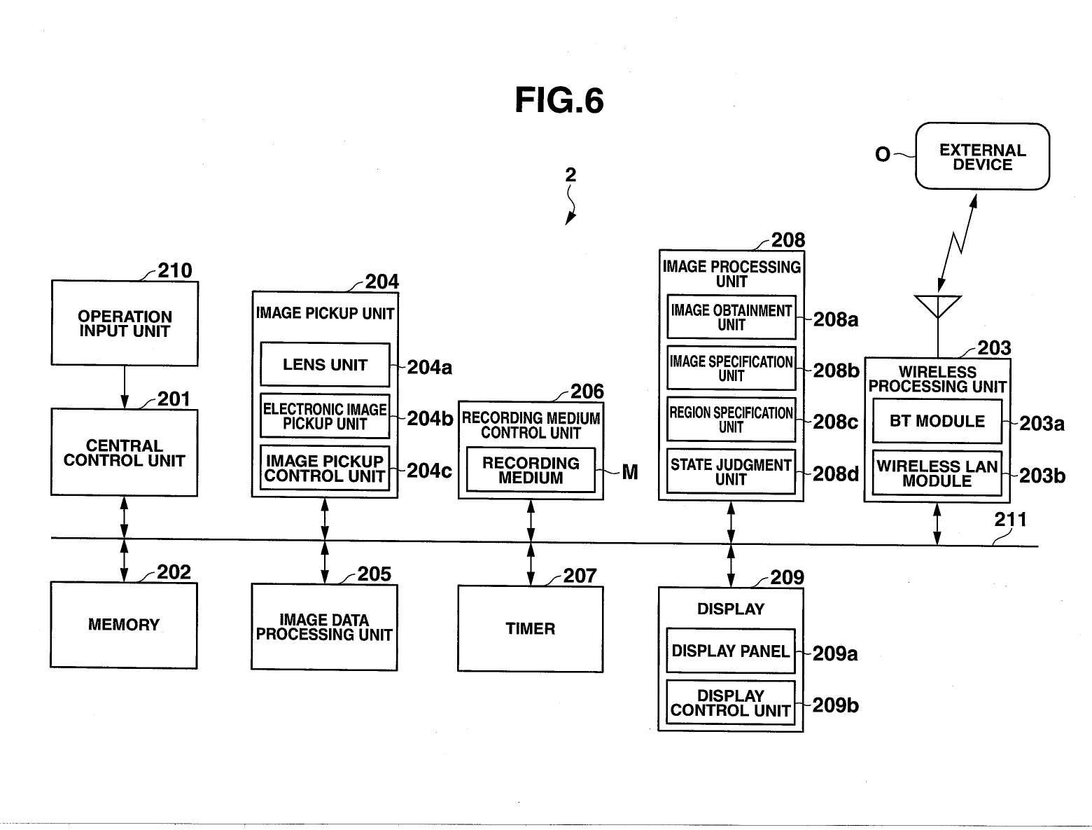

Next, the image pickup apparatuses 2 are described with reference to FIG. 6.

The image specification system 100 includes the plurality of image pickup apparatuses 2 (two image pickup apparatuses 2 are shown in FIG. 2) disposed in such a way as to image the tennis ball B hit with the tennis racket 300 from different directions. For example, of the plurality of image pickup apparatuses 2, one image pickup apparatus 2 (2A) is disposed behind a user who hits the tennis ball B with the tennis racket 300, and the other image pickup apparatuses 2 (2B) are each disposed on the side of the user.

These image pickup apparatuses 2 are connected to each other via the predetermined wireless communication line to communicate with each other, and, of the image pickup apparatuses 2, one image pickup apparatus 2 (2A) acts as a master of cooperative image pickup, and the other image pickup apparatuses 2 (2B) act as slaves thereof. Contents of operation of each image pickup apparatus 2 differ depending on whether the image pickup apparatus 2 acts as the master or the slave. However, the configurations of the image pickup apparatuses 2 are almost the same regardless of acting as the master or the slave.

The “cooperative image pickup” is image pickup realized by the plurality of image pickup apparatuses 2, which perform their respective image pickup operations, working together, for example.

FIG. 6 is a block diagram schematically showing the configuration of each image pickup apparatus 2.

As shown in FIG. 6, an image pickup apparatus 2 includes a central control unit 201, a memory 202, the wireless processing unit 203, an image pickup unit 204, an image data processing unit 205, a recording medium control unit 206, a timer unit 207, an image processing unit 208, a display unit 209 and an operation input unit 210.

The central control unit 201, the memory 202, the wireless processing unit 203, the image pickup unit 204, the image data processing unit 205, the recording medium control unit 206, the timer unit 207, the image processing unit 208 and the display unit 209 are connected to each other via a bus line 211.

The central control unit 201 controls the units and the like of the image pickup apparatus 2. More specifically, the central control unit 201 includes a CPU (Central Processing Unit), a RAM (Random Access Memory) and a ROM (Read Only Memory) (all not shown). The central control unit 201 performs various control operations in accordance with various process programs (not shown) for the image pickup apparatus 2 stored in the ROM. The CPU stores results of the various processes in a storage region in the RAM and displays the results on the display unit 209 as needed.

The RAM includes: a program storage region where, for example, the process programs to be executed by the CPU are opened; and a data storage region where, for example, input data and the results generated by the execution of the process programs are stored.

The ROM stores therein, for example, programs in a form of program codes readable by a computer, such as a system program executable by the image pickup apparatus 2 and the process programs executable by the system program, and data used to execute the process programs.

The memory 102 is constituted of, for example, a DRAM or the like and temporarily stores therein, for example, data processed by the central control unit 201 and the like.

The wireless processing unit 203 performs wireless communication with external devices O, such as the tool terminal 1 and another image pickup apparatus 2, to which the wireless processing unit 203 (image pickup apparatus 2) is connected via the predetermined wireless communication line.

More specifically, the wireless processing unit 203 includes, for example, the Bluetooth® module (BT module) 203a and a wireless LAN module 203b.

The BT module 203a performs wireless communication with the BT module 107a of the tool terminal 1 in accordance with the Bluetooth standard, similarly to the BT module 107a of the tool terminal 1.

The BT module 203a receives the contact time information sent from the BT module 107a of the wireless processing unit 107 of the tool terminal 1. Then, the BT module 203a outputs the received contact time information to the memory 202.

The wireless LAN module 203b acts, for example, by Peer-to-Peer (ad hoc mode) which constructs a wireless communication line with the wireless LAN module 203b of the wireless processing unit 203 of another image pickup apparatus 2 directly, i.e. not via an external access point (fixed base station). In the ad hoc mode, various pieces of communication control information are preset for the wireless communication line, such as a communication method, encoding information, a channel and IP addresses. The wireless LAN module 203b performs wireless communication with the wireless LAN module 203b of the wireless processing unit 203 of the (another) image pickup apparatus 2 which is located within a wireless communication available area and in which the shared communication control information is set.

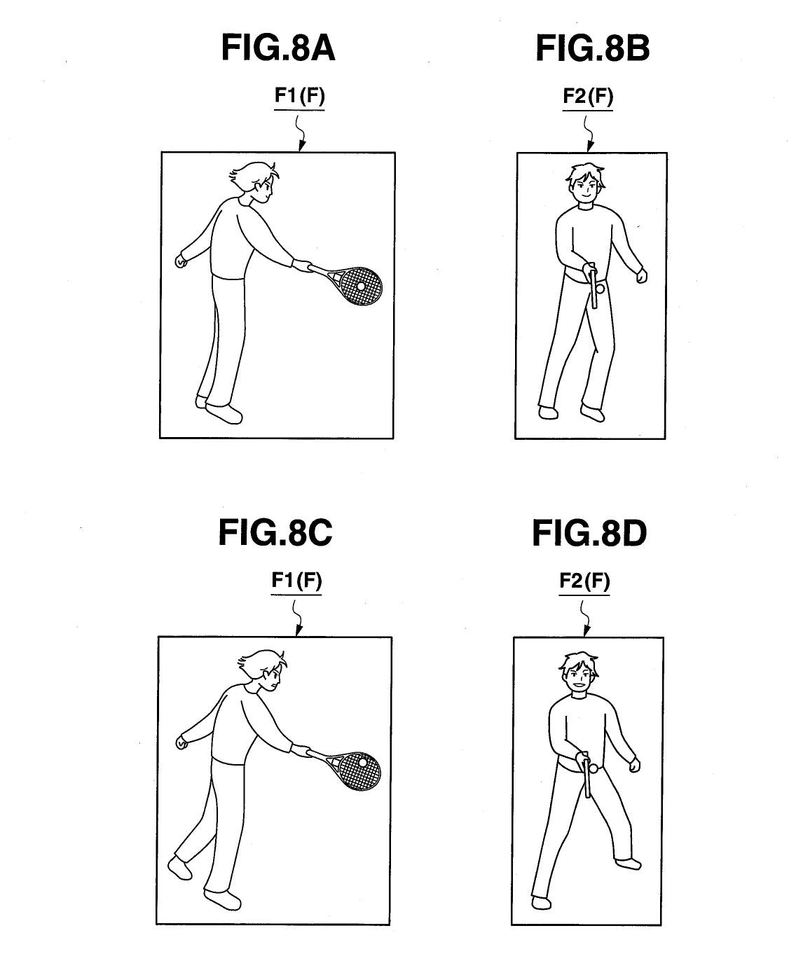

More specifically, in the image pickup apparatus 2A, which acts as the master of the cooperative image pickup, the wireless LAN module 203b sends an obtainment instruction to each image pickup apparatus 2B, which acts as the slave of the cooperative image pickup, via the predetermined wireless communication line. The obtainment instruction is an instruction to obtain image data (see FIG. 8B or 8D, for example) captured by the image pickup apparatus 2B and correlated with the image pickup time information corresponding to the contact time information.

On the other hand, in each image pickup apparatus 2B, which acts as the slave of the cooperative image pickup, the wireless LAN module 203b receives the obtainment instruction to obtain the image data sent from the wireless LAN module 203b of the image pickup apparatus 2A, which acts as the master of the cooperative image pickup, via the predetermined wireless communication line. Then, in response to the received obtainment instruction, the wireless LAN module 203b of each image pickup apparatus 2B obtains the image data correlated with the image pickup time information corresponding to the contact time information from the memory 202 and sends the image data to the image pickup apparatus 2A, which acts as the master of the cooperative image pickup, via the predetermined wireless communication line.

The image pickup unit 204 includes a lens unit 204a, an electronic image pickup unit 204b and an image pickup control unit 204c.

The lens unit 204a is constituted of, for example, multiple lenses, such as a zoom lens and a focus lens.

The electronic image pickup unit 204b is constituted of, for example, an image sensor, such as a CCD (Charge Coupled Device) or a CMOS (Complementary Metal-Oxide Semiconductor), and converts optical images having passed through the various lenses of the lens unit 204a into two-dimensional image signals.

The image pickup unit 204 may include a stop (not shown) which adjusts the amount of light passing through the lens unit 204a.

The image pickup control unit 204c controls image pickup of a subject performed by the electronic image pickup unit 204b. That is, the image pickup control unit 204c includes a timing generator and a driver (both not shown). The image pickup control unit 204c scans and drives the electronic image pickup unit 204b with the timing generator, the driver and the like so as to make the electronic image pickup unit 204b convert optical images formed by the lens unit 204a into two-dimensional image signals at intervals of a predetermined time and consequently reads frame images F (see FIG. 8A, for example) from an image pickup region of the electronic image pickup unit 204b for one screen by one screen so as to output the frame images F to the image data processing unit 205.

The image data processing unit 205 generates image data of a subject.

That is, the image data processing unit 205 successively processes the frame images F captured by the image pickup unit 204. More specifically, the image data processing unit 205 appropriately performs gain control on signals having analog values of the frame images F transferred from the electronic image pickup unit 204b at intervals of a predetermined time (for example, 1/400 sec.) which corresponds to an image pickup frame rate with respect to each color component of RGB, performs sample-holding with a sample hold circuit (not shown), performs conversion into digital data with an analog-to-digital converter (not shown), performs a color process including a pixel interpolation process and a gamma correction process with a color process circuit (not shown) and then generates luminance signals Y having digital values and color difference signals Cb and Cr having digital values (YUV data).

As mentioned above, the image pickup frame rate may be 400 fps but not limited thereto and can be appropriately changed to another.

The image data processing unit 205 compresses YUV data of each frame image F in a predetermined encoding format (JPEG, for example) and outputs the compressed data to the recording medium control unit 206. The image data processing unit 205 generates the image data of each frame image F in such a way as to be correlated with the image pickup time information, for example. The image pickup time information is information on the time which is caught by the timer unit 207 as the time the frame image F is captured (image pickup time).

A recording medium M is detachably attached to the recording medium control unit 206, and the recording medium control unit 206 controls data reading/writing from/on the recording medium M attached thereto.

That is, the recording medium control unit 206 records the image data of each frame image F for recording encoded by an encoding unit (not shown) of the image data processing unit 205 in a predetermined encoding (compression) format (JPEG, motion JPEG or MPEG, for example) in a predetermined recording region of the recording medium M.

The recording medium M is constituted of, for example, a nonvolatile memory (flash memory) or the like.

The timer unit 207 includes a timer or a timer circuit (both not shown) and keeps track of the current time to generate time information.

More specifically, the timer unit 207 catches the time at which the image pickup unit 204 captures each frame image F to generate the image pickup time information on the time of the image pickup. Then, the timer unit 207 outputs the generated image pickup time information to the memory 202.

The timer unit 207 keeps track of the current time in synchronism with the timer unit 105 of the tool terminal 1. That is, the timer unit 207 synchronizes itself with the timer unit 105 in response to a synchronization control signal sent from the tool terminal 1 and received by the BT module 203a to keep track of the current time which is the same as that of the timer unit 105 of the tool terminal 1.

The timer unit 207 may specify, for example, a date and/or a day of week on the basis of the image pickup time information. The synchronization performed by the timer unit 207 may be performed, for example, by using a standard time of a predetermined area received by a GPS processing unit (not shown) as a reference.

The image processing unit 208 includes an image obtainment unit 208a, an image specification unit 208b, a region specification unit 208c and a state (displacement's degree) judgment unit 208d.

Each unit of the image processing unit 208 is constituted of, for example, a predetermined logic circuit. However, this is not a limitation but an example.

The image obtainment unit 208a obtains images around when the tennis ball B is hit with the tennis racket 300, the images being correlated with their respective image pickup time information.

That is, the image obtainment unit 208a obtains images successively captured by the image pickup unit 204 around when the tennis ball B is hit with the tennis racket (tool) 300, the images being correlated with their respective image pickup time information on the times at which the respective images are captured. More specifically, the image obtainment unit 208a obtains a plurality of image data of frame images F correlated with their respective image pickup time information on the times at which the respective frame images F are captured, the plurality of the image data of the frame images F correlated with their respective image pickup time information being generated by the image data processing unit 205, for example.

The image specification unit 208b specifies an image correlated with the image pickup time information corresponding to the contact time information.

That is, the image specification unit 208b specifies, of the frame images F obtained by the image obtainment unit 208a, a frame image F correlated with the image pickup time information corresponding to the contact time information received by the BT module 203a of the wireless processing unit 203. More specifically, the image specification unit 208b obtains the contact time information from the memory 202 and specifies, of the image data of the frame images F showing motion to hit the tennis ball B with the tennis racket 300, image data of a frame image F correlated with the image pickup time information indicating the image pickup time corresponding to the contact time of the tennis racket 300 and the tennis ball B indicated by the obtained contact time information (see FIG. 8A, for example).

Further, the image specification unit 208b of the image pickup apparatus 2A as the master of the cooperative image pickup specifies image data sent from each image pickup apparatus 2B as the slave thereof and received by the wireless LAN module 203b of the wireless processing unit 203. That is, the image specification unit 208b of the image pickup apparatus 2A as the master obtains through the wireless LAN module 203b and specifies image data of a frame image F2 (see FIG. 8B or 8D, for example) captured by each image pickup apparatus 2B as the slave and correlated with the image pickup time information on the image pickup time corresponding to the contact time of the tennis racket 300 and the tennis ball B.

FIGS. 8A to 8D show examples of frame images F captured when a user makes motion to hit the tennis ball B with the tennis racket 300 multiple times. FIGS. 8A and 8C show examples of frame images F1 captured by the image pickup apparatus 2A as the master of the cooperative image pickup each time the user makes the motion. FIGS. 8B and 8D show examples of frame images F2 captured by the image pickup apparatus 2B as the slave of the cooperative image pickup each time the user makes the motion.

The region specification unit 208c specifies an object region A1 and a tool region A2 in an image.

That is, the region specification unit 208c specifies the object region (second object region) A1 corresponding to the tennis ball (second object) B and the tool region (first object region) A2 corresponding to the tennis racket (first object) 300 in the frame image F specified by the image specification unit 208b as a frame image F of the contact time of the tennis racket 300 and the tennis ball B. More specifically, the region specification unit 208c performs, for example, a feature extraction process using the shape of the tennis ball B as a template on a frame image F1 captured by the image pickup apparatus 2A disposed behind a user who hits the tennis ball B with the tennis racket 300 to extract from the frame image F1 and specifies the object region A1 corresponding to the tennis ball B., In addition, the region specification unit 208c extracts from the frame image F1 and specifies the tool region A2 corresponding to the head part 302 (the face) of the tennis racket 300 using a ratio of the number of pixels of the object region A1 to the total number of pixels of the frame image F1, a ratio of the actual size of the head part 302 of the tennis racket 300 to the actual size of the tennis ball B, the shape of the head part 302 as a template and the like.

The methods for extracting and specifying the object region A1 and the tool region A2 are not limited thereto and can be appropriately changed to others.

The state judgment unit 208d judges the state of the contact between the tennis racket 300 and the tennis ball B.

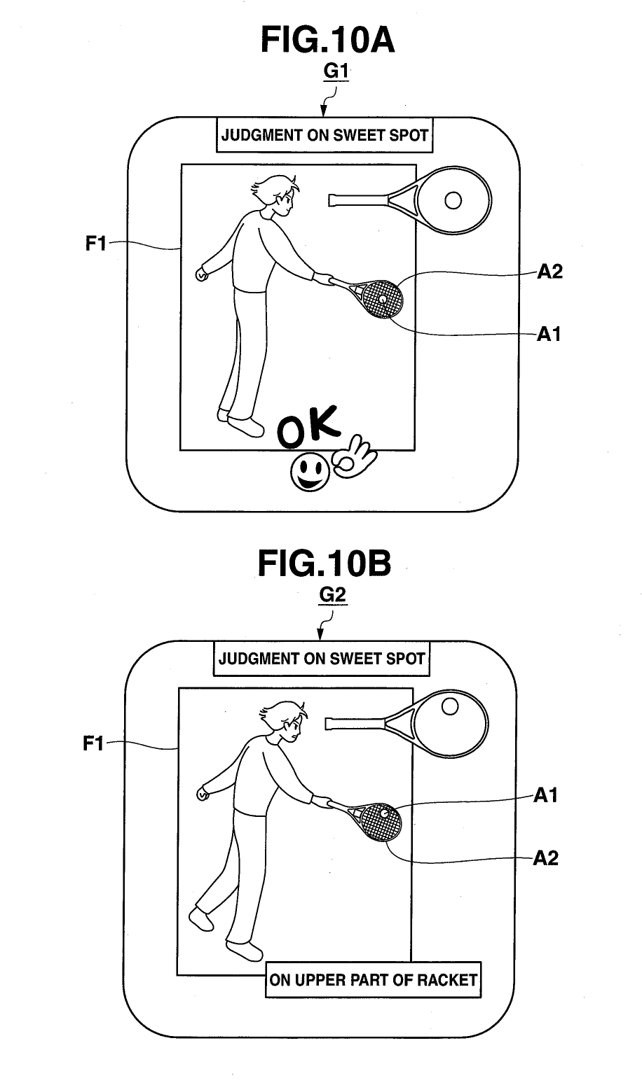

That is, the state judgment unit 208d judges the state of the contact between the tennis racket (tool) 300 and the tennis ball Bon the basis of a positional relationship between the object region A1 and the tool region A2 specified by the region specification unit 208c. More specifically, the state judgment unit 208d judges the state of the contact between the tennis racket 300 and the tennis ball B on the basis of a displacement of the center point of the object region A1 corresponding to the tennis ball B from the center point of the tool region A2 corresponding to the head part 302 of the tennis racket 300 (judgment on the sweet spot; see FIG. 10A, for example). That is, the state judgment unit 208d judges a degree of the displacement.

For example, the state judgment unit 208d determines whether or not the displacement (the number of pixels) of the center point of the object region A1 from the center point of the tool region A2 is equal to or less than a predetermined threshold value. When determining that the displacement is equal to or less than a predetermined threshold value, the state judgment unit 208d judges that the tennis ball B is hit at the approximate center (sweet spot) of the face of the tennis racket 300, and accordingly judges that the hitting way (catching way) of the tennis ball B is good. On the other hand, when determining that the displacement is more than the predetermined threshold value, the state judgment unit 208d judges that the tennis ball B is not hit at the approximate center of the tennis racket 300, and accordingly judges that the hitting way of the tennis ball B is bad.

The display unit 209 includes a display panel 209a and a display control unit 209b.

The display panel 209a displays images in a display screen thereof. Examples of the display panel 209a include a liquid crystal display panel and an organic EL display panel but not limited thereto.

The display control unit 209b reads the image data for display temporarily stored in the memory 202 and performs control to display a predetermined image(s) on the display screen of the display panel 209a on the basis of the image data having a predetermined size decoded by the image data processing unit 205. More specifically, the display control unit 209b includes a VRAM (Video Random Access Memory), a VRAM controller and a digital video encoder (all not shown). The digital video encoder reads the luminance signals Y and the color difference signals Cb and Cr decoded by the image data processing unit 205 and stored in the VRAM from the VRAM via the VRAM controller at a predetermined reproduction frame rate (for example, 30 fps) and generates video signals on the basis of these data to output the video signals to the display panel 209a.

The display control unit 209b displays state judgment screens (for example, a state judgment screen G1) on the display panel 209a (see FIG. 10A, for example). The state judgment screens each show the judgment result made by the state judgment unit 208d regarding the state of the contact between the tennis racket 300 and the tennis ball B.

That is, for example, when the state judgment unit 208d judges that the hitting way of the tennis ball B with the tennis racket 300 is good, the display control unit 209b displays the state judgment screen G1 including an image which schematically shows a state in which the tennis ball B is hit at the approximate center of the face of the tennis racket 300 and a message “OK” which indicates that the hitting way of the tennis ball B is good on the display panel 209a (see FIG. 10A). On the other hand, for example, when the state judgment unit 208d judges that the hitting way of the tennis ball B with the tennis racket 300 is bad, the display control unit 209b displays a state judgment screen G2 including an image which schematically shows a state in which the position of the tennis ball B is displaced from the approximate center of the face of the tennis racket 300 in accordance with the magnitude and the direction of the displacement of the center point of the object region A1 from the center point of the tool region A2 and a message “ON UPPER PART OF RACKET” or the like which indicates that the hitting way of the tennis ball B is bad on the display panel 209a (see FIG. 10B).

Thus, the display panel 209a and the display control unit 209b notify the judgment result made by the state judgment unit 208d regarding the state of the contact between the tennis racket (tool) 300 and the tennis ball B.

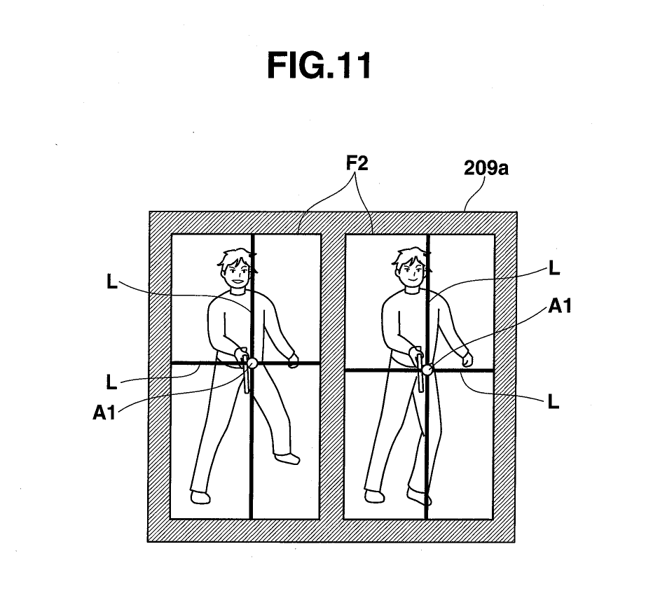

When user's motion to hit the tennis ball B with the tennis racket 300 is imaged multiple times, the display control unit 209b may display a plurality of frame images F specified by the image specification unit 208b at the respective times on the display panel 209a side by side, for example. That is, the display control unit 209b may display a plurality of frame images F (for example, frame images F2) correlated with their respective image pickup time information on the image pickup times corresponding to the contact times of the tennis racket 300 and the tennis ball B on the display panel 209a side by side, for example (see FIG. 11). The display control unit 209b may also display auxiliary lines L such as a vertical line and a horizontal line approximately perpendicular to each other with the position (the center point) of the object region A1 corresponding to the tennis ball B as an intersection point of the lines on each of the frame images F.

The operation input unit 210 is to perform predetermined operations for the image pickup apparatus 2 and includes a power button to turn on/off power of the image pickup apparatus 2, a shutter button for an image pickup instruction to image a subject, a selection/decision button to select an image pickup mode, a function or the like, and a zoom button to adjust a zoom amount (all not shown). The operation input unit 210 outputs predetermined operation signals corresponding to the buttons operated to the central control unit 201.

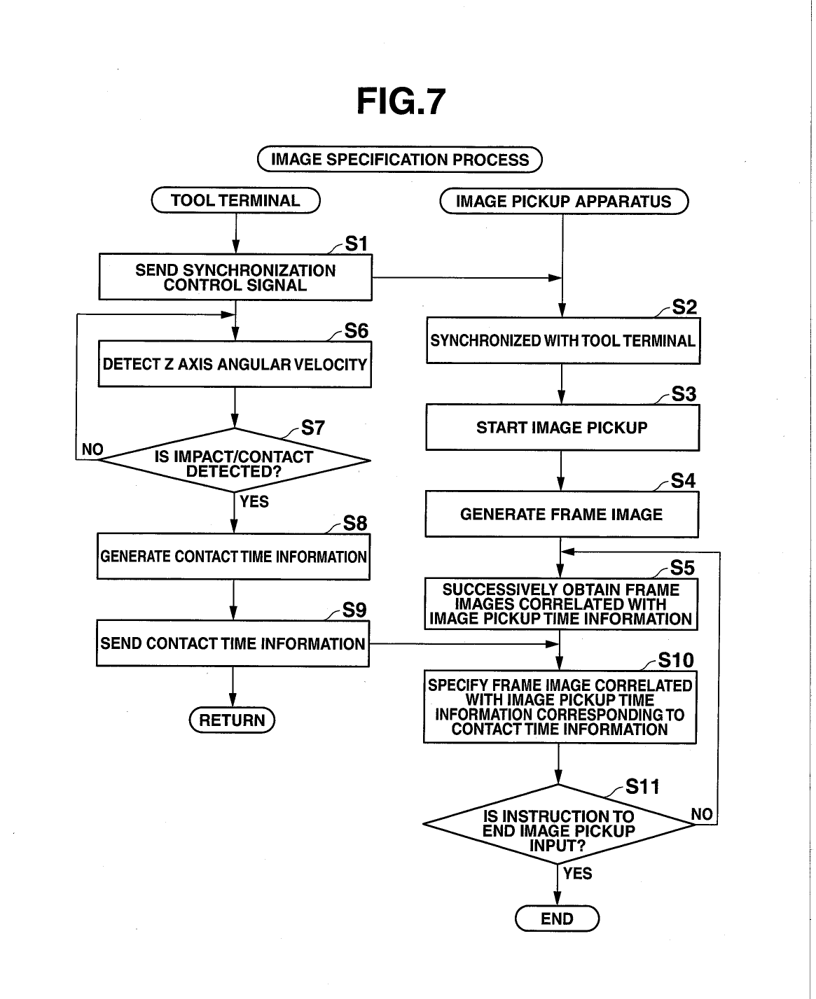

Next, an image specification process performed by the image specification system 100 is described with reference to FIGS. 7 and 8.

FIG. 7 is a flowchart showing an example of operation of the image specification process.

Note that the tool terminal 1 is attached to the shaft part 303 of the tennis racket 300. In addition, the below-described steps of the image pickup apparatus 2 are taken by each of the image pickup apparatuses 2.

As shown in FIG. 7, first, in the tool terminal 1, the BT module 107a of the wireless processing unit 107 sends a synchronization control signal to synchronize the timer unit 105 of the tool terminal 1 with the timer unit 207 of each image pickup apparatus 2 to each image pickup apparatus 2 (Step S1).

In each image pickup apparatus 2, when the BT module 203a of the wireless processing unit 203 receives the synchronization control signal, the timer unit 207 synchronizes itself with the timer unit 105 of the tool terminal 1 in response to the synchronization control signal (Step S2).

After that, when an image pickup instruction is input into the CPU of the center control unit 201 in response to a predetermined operation by a user onto the operation input unit 210, the image pickup apparatus 2 starts imaging a subject (Step S3), and the image pickup control unit 204c reads two-dimensional image signals into which optical images formed by the lens unit 204a are converted by the electronic image pickup unit 204b, namely, reads frame images F from the image pickup region of the electronic image pickup unit 204b at a predetermined image pickup frame rate for one screen by one screen so as to output the frame images F to the image data processing unit 205. Next, the image data processing unit 205 generates image data of each frame image F correlated with the image pickup time information on the time caught by the timer unit 207 as the time the frame image F is captured (Step S4). Then, the image data processing unit 205 outputs the generated image data of the frame images F to the memory 202.

Next, the image obtainment unit 208a of the image processing unit 208 successively obtains the image data of the frame images F correlated with their respective image pickup time information from the memory 202 (Step S5).

Meanwhile, in the tool terminal 1, when a user makes motion to hit the tennis ball B with the tennis racket 300, the angular velocity detection unit 103 detects the Z axis angular velocity Gz of the tool terminal 1 which rotates around the Z axis and outputs the detected value of the Z axis angular velocity Gz to the contact detection unit 104 (Step S6).

The contact detection unit 104 determines whether or not contact (impact) between the tennis racket 300 and the tennis ball B is detected on the basis of the value of the Z axis angular velocity output from the angular velocity detection unit 103 (Step S7). The contact detection unit 104 determines, whether or not contact between the tennis racket 300 and the tennis ball B is detected (Step S7) each time the value of the Z axis angular velocity Gz is input until the contact detection unit 104 determines that the contact therebetween is detected (Step S7; YES)

When determining that the contact between the tennis racket 300 and the tennis ball B is detected (Step S7; YES), the contact detection unit 104 outputs the timing information which indicates the timing at which the tennis racket 300 and the tennis ball B contact with each other to the timer unit 105, and the timer unit 105 generates the contact time information on the time at which the tennis ball B and the tennis racket 300 contact with each other in response to input of the timing information (Step S8). Then, the timer unit 105 outputs the generated contact time information to the wireless processing unit 107.

Next, when the contact time information output from the timer unit 105 is input, the BT module 107a of the wireless processing unit 107 sends the contact time information to each image pickup apparatus 2 (Step S9).

In each image pickup apparatus 2, when the BT module 203a of the wireless processing unit 203 receives the contact time information, the image specification unit 208b specifies, of the frame images F obtained by the image obtainment unit 208a, a frame image F correlated with the image pickup time information corresponding to the contact time information (Step S10; see FIG. 8A, for example). That is, the image specification unit 208b specifies image data of a frame image F correlated with the image pickup time information on the image pickup time corresponding to the contact time of the tennis racket 300 and the tennis ball B.

After that, the recording medium control unit 206 records the specified image data of the frame image F on the recording medium M.

After that, the CPU of the central control unit 201 determines whether or not an instruction to end imaging the subject is input in response to a predetermined operation by a user onto the operation input unit 210 (Step S11).

When determining that an instruction to end image pickup is not input (Step S11; NO), the CPU of the central control unit 201 returns the process to Step S5 so that the image obtainment unit 208a successively obtains image data of frame images F correlated with their respective image pickup time information (Step S5).

On the other hand, when determining that an instruction to end image pickup is input (Step S11; YES), the CPU of the central control unit 201 ends the image specification process.

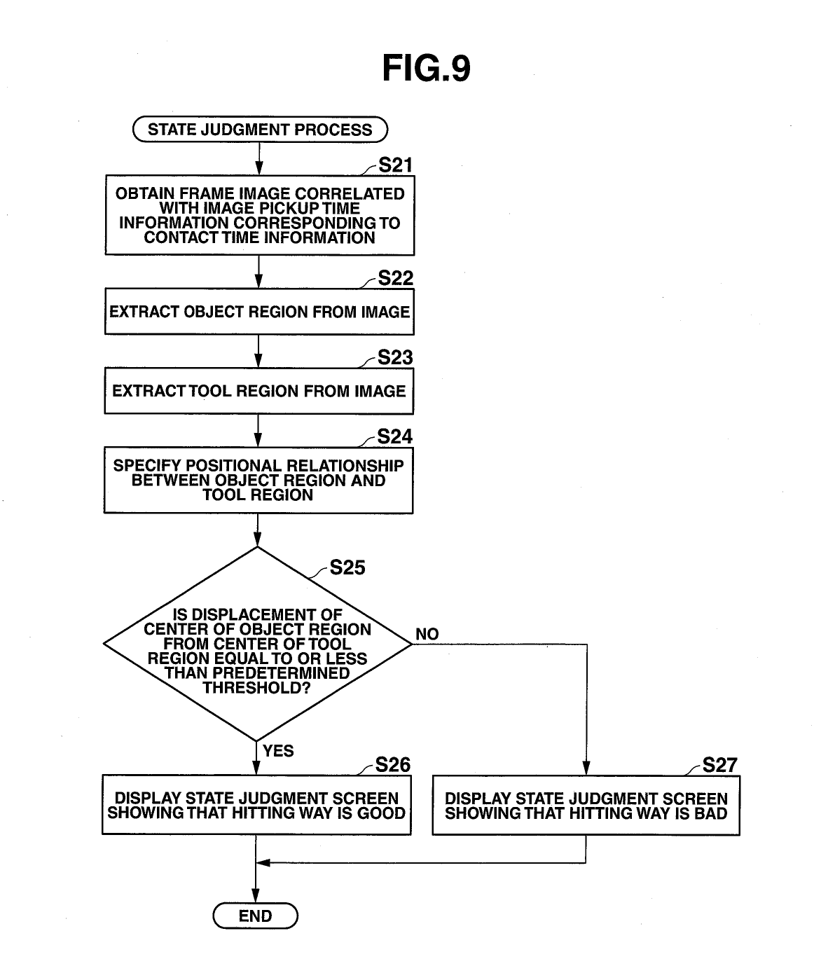

Next, a state judgment process performed by the image pickup apparatus 2 is described with reference to FIGS. 9 and 10.

FIG. 9 is a flowchart showing an example of operation of the state judgment process.

In the embodiment, the state judgment process is performed by one image pickup apparatus 2 (2A) disposed behind a user who hits the tennis ball B with the tennis racket 300, but may be performed by each image pickup apparatus 2.

As shown in FIG. 9, first, the region specification unit 208c of the image processing unit 208 obtains image data of a frame image F1 correlated with the image pickup time information on the image pickup time corresponding to the contact time of the tennis racket 300 and the tennis ball B (Step S21).

Next, the region specification unit 208c extracts the object region A1 corresponding to the tennis ball B from the obtained frame image F1 (Step S22). More specifically, the region specification unit 208c performs the feature extraction process using the shape of the tennis ball B as a template to extract the object region A1 corresponding to the tennis ball B from the frame image F1.

Next, the region specification unit 208c extracts the tool region A2 corresponding to the head part 302 of the tennis racket 300 from the frame image F1 (Step S23). More specifically, the region specification unit 208c extracts the tool region A2 corresponding to the head part 302 of the tennis racket 300 from the frame image F1 using a ratio of the number of pixels of the object region A1 to the total number of pixels of the frame image F1, a ratio of the actual size of the head part 302 of the tennis racket 300 to the actual size of the tennis ball B, the shape of the head part 302 as a template and the like.

Next, the state judgment unit 208d of the image processing unit 208 specifies the positional relationship between the object region A1 and the tool region A2 specified by the region specification unit 208c (Step S24) and determines whether or not the displacement of the center point of the object region A1 corresponding to the tennis ball B from the center point of the tool region A2 corresponding to the head part 302 of the tennis racket 300 is equal to or less than a predetermined threshold value (Step S25).

When the state judgment unit 208d determines that the displacement is equal to or less than a predetermined threshold value (Step S25; YES), the state judgment unit 208d judges that the hitting way of the tennis ball B is good, and the display control unit 209b displays the state judgment screen G1, which shows that the hitting way of the tennis ball B is good, on the display panel 209a (Step S26; see FIG. 10A).

On the other hand, when the state judgment unit 208d determines that the displacement is more than the predetermined threshold value (Step S25; NO), the state judgment unit 208d judges that the hitting way of the tennis ball B is bad, and the display control unit 209b displays the state judgment screen G2, which shows that the hitting way of the tennis ball B is bad, on the display panel 209a (Step S27; see FIG. 10B).

When the state judgment process is performed by the image pickup apparatus 2B disposed on the side of a user who hits the tennis ball B with the tennis racket 300, the display control unit 209b displays the auxiliary lines L such as a vertical line and a horizontal line to show the positional relationship of the object region A1, which is specified by the region specification unit 208c, corresponding to the tennis ball B to a predetermined region of a frame image F2 (see FIG. 11). Accordingly, the state of the contact between the tennis racket (tool) 300 and the tennis ball B, namely, the state of a user hitting the tennis ball B with the tennis racket 300, can be displayed in such a way that the user. can easily know the state.

As described above, according to the image specification system 100 of the embodiment, (i) a plurality of images successively captured by the image pickup unit 204 around when a first object (for example, the tennis racket 300) and a second object (for example, the tennis ball B) contact with each other and correlated with their respective image pickup time information on times at which the respective images are captured are obtained; (ii) contact between the first object and the second object is detected; and (iii) of the obtained images, an image correlated with image pickup time information corresponding to contact time information on a time at which the contact between the first object and the second object is detected is specified. Accordingly, the moment at which the first object and the second object contact with each other can be accurately specified, and an image of the time when the first object and the second object contact with each other can be easily specified from among a plurality of images. In addition, as compared with the conventional case where a sound is used, an image of the time when the first object and the second object contact with each other can be more accurately specified.

Further, the object region A1 corresponding to the second object and the tool region A2 corresponding to the first object are specified in the specified image, and the state of the contact between the first object and the second object is judged on the basis of a positional relationship between the object region A1 and the tool region A2. Accordingly, whether a state of the time when the second object is hit with a tool as the second object, namely, a hitting way of the second object with the tool, is good or bad can be judged. Further, the state of the contact between the first object and the second object is notified. Accordingly, a user can know his/her body movement or condition of the time when the user hits the second object with the tool.

Further, of a plurality of images captured by the image pickup units 204 of the image pickup apparatuses 2 from different directions around when the first object and the second object contact with each other, a plurality of images each correlated with the image pickup time information corresponding to the contact time information are specified. Accordingly, the images captured from different directions at the time when the first object and the second object contact with each other (when the second object is hit with the tool) can be compared with each other, and hence a user can easily know his/her body movement or condition of the time when the user hits the second object with the tool.

Further, the contact between the first object and the second object can detected on the basis of an angular velocity of the tool terminal 1 which rotates around a predetermined axis. More specifically, the contact between the tool as the first object and the second object can be detected on the basis of an angular velocity (Z axis angular velocity Gz) of the tool terminal 1 which rotates around an axis (Z axis) which is approximately parallel to a surface of the tool as the first object (for example, the face of the tennis racket 300), the surface including the hitting part to hit the second object, and approximately perpendicular to the extending direction of the holding part (for example, the grip part 301) of the tool, the holding part being held by a user. Accordingly, the contact between the tool and the second object can be accurately detected with a simple configuration.

The present invention is not limited to the above embodiment, and hence various modifications and design changes can be made without departing from the scope of the present invention.

In the embodiment, the contact between the tennis racket (tool) 300 and the tennis ball (second object) B is detected by using the angular velocity detected by the angular velocity detection unit 103. However, this is not a limitation but an example. Hence, a rate of acceleration of the tool terminal 1 may be used therefor. That is, any sensor can be used therefor as long as movement of the tennis racket 300 can be detected.

Further, in the embodiment, the contact of the tennis ball B onto the tennis racket 300 is detected. However, this is not a limitation but an example. Hence, any configuration can be used as long as the contact between the tennis racket 300 and the tennis ball B can be detected.

Further, in the embodiment, the contact between the tennis racket 300 and the tennis ball B is detected. However, the positional relationship between the first object (for example, the tennis racket 300) and the second object (for example, the tennis ball B) is not limited to that for contact. That is, for example, it may be detected that user's swing motion of the tennis racket 300 to the tennis ball B (the positional relationship between the first object and the second object) is one of the states, such as the “Ready Position”, “Take-Back”, “Impact” and “Follow-Through”, on the basis of an angular velocity component of at least one axis among the three axes.

Further, in the embodiment, Steps S7 and S8 shown in FIG. 7 are taken care of by the tool terminal 1. However, these steps may be taken care of by the image pickup apparatus 2. That is, the tool terminal 1 correlates and sends to each image pickup apparatus 2 time information on the time caught by the timer unit 105 with the value of the angular velocity Gz detected at Step S6, and the image pickup apparatus 2 detects the contact (impact) of the tennis ball B onto the tennis racket 300 on the basis of the value of the angular velocity Gz and the time information and generates the contact time information, thereby specifying a frame image correlated with the image pickup time information corresponding to the contact time information.

Further, in the embodiment, the state of the contact between the tennis racket (tool or first object) 300 and the tennis ball (second object) B is judged. However, this is not a limitation but an example. Hence, this judgment is not always necessary to make. That is, whether or not to make the image pickup apparatus 2 have the region specification unit 208c and the state judgment unit 208d can be appropriately decided.

Further, in the embodiment, the tennis racket 300 is used as the tool. However, this is not a limitation and hence the tennis racket 300 can be changed to any tool with which an object (second object) is hit, such as a table-tennis racket, a baseball bat or a golf club. In this case, it is preferable that the tool terminal 1 be attached to an axis in the extending direction of the holding part, which is held by a user, to be fixed thereto.

Further, the configuration of the image specification system 100 described in the embodiment is an example and hence not limited thereto. For example, although a wireless communication line is described as the predetermined communication line, the predetermined communication line may be a cable communication line, so that the tool terminal 1 and the image pickup apparatuses 2 communicate with each other by being connected to each other with a cable or the like.

Further, although the case where a sport such as tennis is played is described in the embodiment, the present invention is applicable to, for example, detecting a crash in an accident and specifying an image of the moment or detecting contact (crash) in continuously-captured moving images and specifying moving images before and after the contact (moving images of user's swing in the case of tennis and moving images before and after a crash in the case of an accident).

Further, in the embodiment, the image specification system 100 includes the tool terminal 1 and the image pickup apparatuses 2. However, this is not a limitation but an example. Hence, the present invention may be constituted of one image specification apparatus. That is, any configuration can be used as long as the configuration includes: an obtainment unit which obtains a plurality of images successively captured by an image pickup unit around when a first object and a second object contact with each other and correlated with respective image pickup time information on times at which the respective images are captured; a contact detection unit (determination unit) which detects the contact between the first object and the second object; and an image specification unit which specifies, from the images obtained by the obtainment unit, an image correlated with image pickup time information corresponding to the time of the contact detected by the contact detection unit.

In addition, functions as a first obtainment unit, a second obtainment unit and an image specification unit may be realized by the CPU of the central control unit of the image specification apparatus executing a predetermined program or the like. That is, a program including a first obtainment process routine, a second obtainment process routine and an image specification process routine is stored in a program memory (not shown) where computer readable programs are stored, and the CPU of the central control unit functions: through the first obtainment process routine as a first obtainment unit which obtains first time information on a time at which a positional relationship between a first object and a second object is a predetermined state from an external device; through the second obtainment process routine as a second obtainment unit which obtains a plurality of images successively captured by an image pickup unit and correlated with respective second time information on times at which the respective images are captured; and through the image specification process routine as an image specification unit which specifies, from the images obtained by the second obtainment unit, an image correlated with second time information corresponding to the first time information obtained by the first obtainment unit.

Similarly, functions as a region specification unit, a judgment unit and a detection unit may also be realized by the CPU of the central control unit executing a predetermined program or the like.

Further, functions as a first obtainment unit, a first specification unit, a second obtainment unit and a second specification unit may be realized by the CPU of the central control unit executing a predetermined program or the like. That is, a program including a first obtainment process routine, a first specification process routine, a second obtainment process routine and a second specification process routine is stored in a program memory (not shown) where computer readable programs are stored, and the CPU of the central control unit functions: through the first obtainment process routine as a first obtainment unit which obtains motion information on motion of a subject correlated with first time information on the motion; through the first specification process routine as a first specification unit which specifies a time at which a positional relationship between a first object and a second object is a predetermined state on the basis of the motion information and the first time information obtained by the first obtainment unit; through the second obtainment process routine as a second obtainment unit which obtains a plurality of images successively captured by an image pickup unit and correlated with respective second time information on times at which the respective images are captured; and through the second specification process routine as a second specification unit which specifies, from the images obtained by the second obtainment unit, an image correlated with second time information corresponding to the time specified by the first specification unit.

Further, as a computer readable medium where the programs to perform the above-described processes are stored, other than a ROM or a hard disk, a nonvolatile memory such as a flash memory or a portable storage medium such as a CD-ROM may be used. Further as a medium to provide data of the programs via a predetermined communication line, a carrier wave may be used.

Some embodiments of the present invention are described above. However, the scope of the present invention is not limited to the embodiments but includes the scope of claims attached below and their equivalents.

What is claimed is:

1. An image specification system comprising:
a sender; and
a receiver,
the sender including:
a determination unit which determines whether a positional relationship between a first object provided with the sender and a second object is a predetermined state; and
a sending unit which sends first time information on a time at which the positional relationship is the predetermined state to the receiver when the determination unit determines that the positional relationship is the predetermined state, and
the receiver including:
a receiving unit which receives the first time information sent from the sending unit;
an obtainment unit which obtains a plurality of images successively captured by an image pickup unit and correlated with respective second time information on times at which the respective images are captured; and
an image specification unit which specifies, from the images correlated with the respective second time information, an image correlated with second time information corresponding to the first time information.

2. The image specification system according to claim 1 further comprising:
a region specification unit which specifies a first object region of the first object and a second object region of the second object in the image specified by the image specification unit; and
a judgment unit which judges a degree of a displacement of the second object region from the first object region.

3. The image specification system according to claim 2 further comprising a notifying unit which notifies a result of the judgment made by the judgment unit.

4. The image specification system according to claim 1, wherein the image specification unit specifies a plurality of images each correlated with the second time information corresponding to the first time information, the images being captured by the image pickup unit and another image pickup unit from different directions.

5. The image specification system according to claim 1, wherein
the sender is attached to a predetermined tool as the first object,
the determination unit determines whether the positional relationship between the tool as the first object and the second object is a contact state between the first object and the second object as the predetermined state,
the sending unit sends the first time information on the time at which the positional relationship is the contact state to the receiver, and
the obtainment unit obtains a plurality of images around when the second object is hit with the tool as the images around when the first object and the second object contact with each other, the plurality of images being correlated with the respective second time information.

6. The image specification system according to claim 5, wherein
the sender further includes a detection unit which detects a rate of acceleration of the sender or an angular velocity of the sender which rotates around a predetermined axis, and
the determination unit determines whether the positional relationship is the contact state based on the rate of acceleration or the angular velocity detected by the detection unit.

7. The image specification system according to claim 6, wherein the detection unit detects the angular velocity of the sender rotating around the predetermined axis which is approximately parallel to a surface of the tool, the surface including a hitting part to hit the second object, and approximately perpendicular to an extending direction of a holding part of the tool, the holding part being held by a user.

8. The image specification system according to claim 1, wherein the determination unit determines whether the positional relationship between the first object and the second object is a contact state between the first object and the second object as the predetermined state.

9. An image specification method using a sender and a receiver, the image specification method comprising:
a determination step of determining whether a positional relationship between a first object provided with the sender and a second object is a predetermined state;
a sending step of sending first time information on a time at which the positional relationship is the predetermined state to the receiver when that the positional relationship is the predetermined state is determined in the determination step;
a receiving step of receiving the first time information sent from the sender;
an obtainment step of obtaining a plurality of images successively captured by an image pickup unit and correlated with respective second time information on times at which the respective images are captured; and
an image specification step of specifying, from the images correlated with the respective second time information, an image correlated with second time information corresponding to the first time information.

10. An image specification apparatus comprising:
a receiving unit which receives first time information on a time at which a positional relationship between a first object and a second object is a predetermined state from an external device;
an obtainment unit which obtains a plurality of images successively captured by an image pickup unit and correlated with respective second time information on times at which the respective images are captured; and
an image specification unit which specifies, from the images correlated with the respective second time information, an image correlated with second time information corresponding to the first time information.

11. The image specification apparatus according to claim 10, wherein the predetermined state is a contact state between the first object and the second object.

12. An image specification method comprising:
a receiving step of receiving first time information on a time at which a positional relationship between a first object and a second object is a predetermined state from an external device;
an obtainment step of obtaining a plurality of images successively captured by an image pickup unit and correlated with respective second time information on times at which the respective images are captured; and
an image specification step of specifying, from the images correlated with the respective second time information, an image correlated with second time information corresponding to the first time information.

13. A computer readable storage medium where a program is stored, the program making a computer function as:
a first obtainment unit which obtains first time information on a time at which a positional relationship between a first object and a second object is a predetermined state from an external device;
a second obtainment unit which obtains a plurality of images successively captured by an image pickup unit and correlated with respective second time information on times at which the respective images are captured; and
an image specification unit which specifies, from the images correlated with the respective second time information, an image correlated with second time information corresponding to the first time information.

14. An image specification apparatus comprising:
a first obtainment unit which obtains motion information on motion of a subject correlated with first time information on the motion;
a first specification unit which specifies a time at which a positional relationship between a first object and a second object is a predetermined state based on the motion information and the first time information;
a second obtainment unit which obtains a plurality of images successively captured by an image pickup unit and correlated with respective second time information on times at which the respective images are captured; and
a second specification unit which specifies, from the images correlated with the respective second time information, an image correlated with second time information corresponding to the specified time.

15. The image specification apparatus according to claim 14, wherein the predetermined state is a contact state between the first object and the second object.

16. An image specification method comprising:
a first obtainment step of obtaining motion information on motion of a subject correlated with first time information on the motion;
a first specification step of specifying a time at which a positional relationship between a first object and a second object is a predetermined state based on the motion information and the first time information;
a second obtainment step of obtaining a plurality of images successively captured by an image pickup unit and correlated with respective second time information on times at which the respective images are captured; and
a second specification step of specifying, from the images correlated with the respective second time information, an image correlated with second time information corresponding to the specified time.

17. A computer readable storage medium where a program is stored, the program making a computer function as:
a first obtainment unit which obtains motion information on motion of a subject correlated with first time information on the motion;
a first specification unit which specifies a time at which a positional relationship between a first object and a second object is a predetermined state based on the motion information and the first time information;
a second obtainment unit which obtains a plurality of images successively captured by an image pickup unit and correlated with respective second time information on times at which the respective images are captured; and
a second specification unit which specifies, from the images correlated with the respective second time information, an image correlated with second time information corresponding to the specified time.
